(19) United States
(12) Patent Application Publication
(10) Pub. No.: US 2025/0229299 A1
(43) Pub. Date: Jul. 17, 2025

(54) SYSTEM AND CLEANER FOR CLEANING SOLAR PANELS

(71) Applicant: SAUDI ARABIAN OIL COMPANY, Dhahran (SA)

(72) Inventors: Raed Alahmdi, Thuwal (SA); Ali Alwehaibi, Riyadh (SA); Bodong Li, Dhahran (SA)

(73) Assignee: SAUDI ARABIAN OIL COMPANY, Dhahran (SA)

(21) Appl. No.: 18/414,792

(22) Filed: Jan. 17, 2024

(51) Int. Cl. B08B 1/30; B08B 1/12; B08B 13/00; H02S 40/10

(52) U.S. Cl. CPC B08B 1/30; B08B 1/12; B08B 13/00; H02S 40/10

(57) ABSTRACT

Systems and cleaners for cleaning a solar panel include a cleaner. The cleaner includes a fixed arm, a moving arm and an actuator. The fixed arm comprises a first fixed bar and a second fixed bar which are connected with each other at a connecting end and form an angle to each other. The moving arm includes a first moving bar and a second moving bar, which are connected to each other at a connecting end and form an angle to each other. The actuator is configured to drive the moving arm to move on the surface of the solar panel along both the first fixed bar and the second fixed bar toward the connecting end of the first fixed bar and the second fixed bar.

### BACKGROUND

This disclosure relates to the cleaning of solar panels. In particular, systems and cleaners are provided for cleaning solar panels, such as small solar panel systems commonly used on oil and gas platforms for powering off-grid systems.

Maintaining solar energy systems to be efficient requires regular cleaning of solar panels. There are various cleaning methods available, each with advantages and disadvantages. For one example, a manual cleaning method involves physically removing dirt and dust using a cleaning tool such as a brush or cloth. This method is cost-effective as it doesn't require additional resources like water or chemicals, but it can be time-consuming and not always effective at removing all the dirt. Another method is to use soaps, detergents, surfactants, or other chemicals for removing stubborn dirt and grime. While effective, these can be hazardous to humans and the environment and may cause damage to solar panels if used excessively. Finally, automated cleaning systems are also commonly used, which include advanced technology such as brushes, robotic arms, and high-pressure hoses to provide a thorough cleaning. However, this method can be expensive and consume large amounts of water, which may lead to environmental concerns.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments relate to a system for cleaning a solar panel. The system may comprise a cleaner which comprises a fixed arm, a moving arm, and an actuator, a controller, a sensor, and a user interface.

In another aspect, embodiments relate to a cleaner for cleaning a solar panel. The cleaner comprises a fixed arm, a moving arm, and an actuator. The fixed arm is configured to be fixed relative to the solar panel, wherein the fixed arm comprises a first fixed bar and a second fixed bar which are connected to each other at a connecting end and are perpendicular to each other. The moving arm is configured to move under guidance of the fixed arm on the surface of the solar panel to be cleaned, wherein the moving arm comprises a first moving bar and a second moving bar which are connected to each other at a connecting end and are perpendicular to each other, and a cleaning brush is disposed along each of the first moving bar and the second moving bar. The actuator is configured to drive the moving arm to move on the surface of the solar panel along both the first fixed bar and the second fixed bar toward the connecting end of the first fixed bar and the second fixed bar.

In a further aspect, embodiments relate to a cleaner for cleaning a solar panel. The cleaner comprises a fixed arm, a moving arm, and an actuator. The moving arm is configured to move along a surface of the solar panel and comprises a first moving bar and a second moving bar which are connected to each other at a connecting end and are oriented to be perpendicular to each other, each of the first moving bar and the second moving bar having a guiding slot extending longitudinally, and a cleaning brush is disposed along the first moving bar and the second moving bar. The fixed arm is configured to be fixed relative to the solar panel, wherein the fixed arm comprises a first fixed bar and a second fixed bar which are connected to each other at a connecting end, a driving pulley disposed at the connecting end of the fixed arm, a first idle pulley disposed at a free end of the first fixed bar, a second idle pulley disposed at a free end of the second fixed bar, a first belt or chain extending between the driving pulley and the first idle pulley, the first belt or chain having a first pin inserted into and sliding along the guiding slot of the first moving bar, a second belt or chain extending between the driving pulley and the second idle pulley, the second belt or chain having a second pin inserted into and sliding along the guiding slot of the second moving bar. The actuator is configured to rotate the driving pulley.

In light of the structure, steps and functions described above, embodiments of the disclosure may include respective means adapted to carry out various steps and functions defined above in accordance with one or more aspects and any one of the embodiments of one or more aspects described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a block diagram of a system for cleaning a solar panel in one or more embodiments.

FIGS. 2A, 2B, and 2C show a schematic diagram of a cleaner in various stages of a cleaning cycle in one or more embodiments.

FIG. 3 is a perspective view of a cleaner in one or more embodiments.

FIG. 4 is a plan view of the cleaner of FIG. 3.

FIG. 5 is a schematic diagram of a driving pulley including a plurality of longitudinal portions of different diameters.

FIG. 6 is a block diagram of a computer system in one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor is it intended to limit any element to being only a single element unless expressly disclosed, such as using the terms “before”, “after”, “single”, and other such terminology. Rather, the use of ordinal numbers is to distinguish between the elements. By way of example, a first element is distinct from a second element, and the first element may encompass more than one element and succeed (or precede) the second element in an ordering of elements.

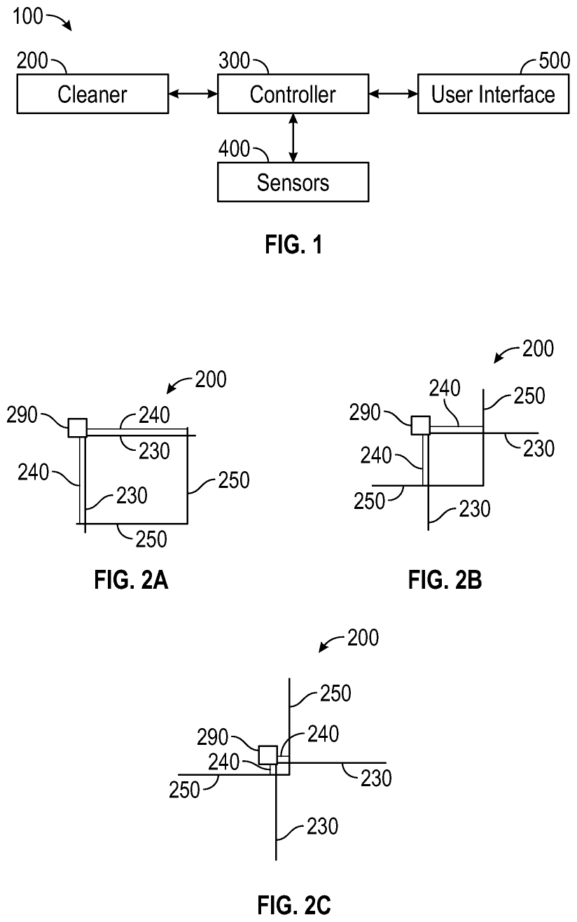

FIG. 1 shows a block diagram of a system 100 for cleaning a solar panel in one or more embodiments. The system may include a cleaner 200, a controller 300, one or more sensors 400 and a user interface 500. In general, the controller 300 may receive from the sensor 400 information about conditions and status for controlling the cleaner 200 to perform cleaning operations, and the cleaning cycle and status of the cleaner 200 may be set, adjusted, and monitored with the user interface 500.

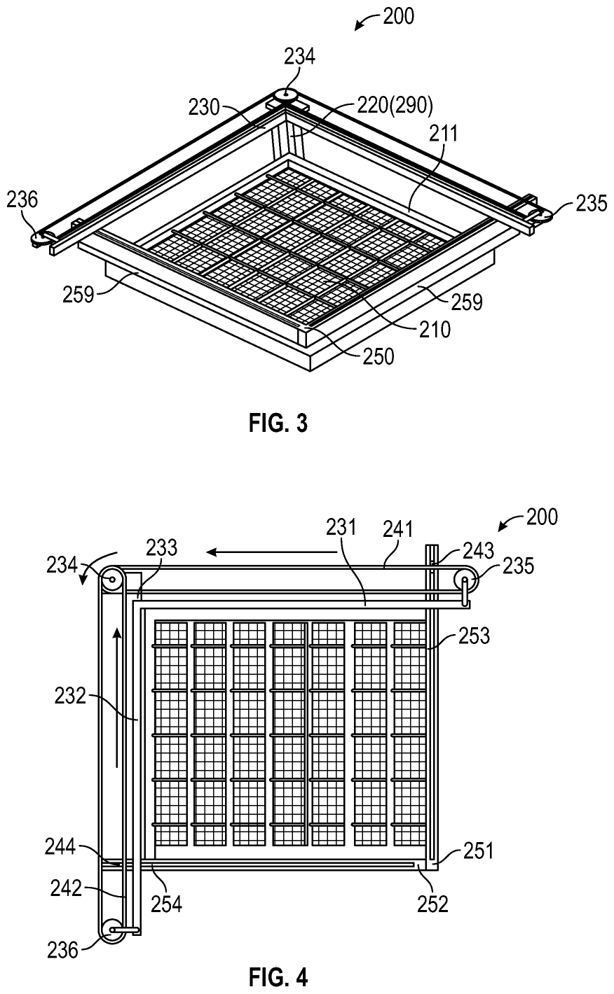

The cleaner 200 may be provided with a cleaning brush and an actuator (shown in FIG. 3) such that the cleaner 200 may be driven by the actuator under control to move on the surface of the solar panels to be cleaned. More details of the cleaner 200 will be described below.

The sensor 400 may include, for instance, motion sensors that may be embedded in the cleaner 200 or located in other positions to capture information on the status of the cleaner 200. In one or more embodiments, the motion sensors can use any feasible technology, such as infrared, ultrasonic or laser sensors, or other means to detect the distance to the surface of the solar panel and map the cleaner's position in its environment. The sensor 400 may also include one or more other sensors, such as humidity sensors, wind sensors, visibility sensors, rain sensors that provide information about environmental conditions. These sensors may be configured to monitor real time information. Such sensors may be positioned in proximity to the cleaner, i.e., in an area of the solar panels to be cleaned, to provide location specific data about external conditions that affect the cleaner and the solar panels to be cleaned.

The controller 300 communicates with the cleaner 200 and the sensor 400 via wireless or wired connection. For example, in order to receive and transmit data, the sensor 400 may transmit the information obtained or collected via RF to the controller 300. The sensor 400 may provide critical feedback to the controller 400 during operation. For example, the sensor 400 may detect changes in the environment and provide real-time information to the controller 400, allowing the controller 300 to adjust the cleaner's motion and orientation according to preset programs.

The controller 300 may include a memory and a processor. The memory may include a read-only memory (ROM), in which various programs are stored, and a random-access memory (RAM), in which various data are temporarily stored. The processor loads programs stored in the ROM into the RAM and executes various processing operations in cooperation with the RAM. The processor communicates with and receives sensing information from the sensors and, after performing necessary processing of the sensing information, further communicates with and stores data in the memory. The processor may also be configured to provide control signals for controlling the cleaner's motion and orientation.

The user interface (UI) 500 may be any device suitable for a user to set, adjust, and monitor the cleaning cycle of the cleaner via the controller 500. The user interface 500 communicates with the controller 300 and may further be coupled to other systems, such as a computer system for performing more computations and monitoring. For example, the user interface may be a touch screen or may include a display screen, a keyboard, and a mouse.

Though not shown in the figure, additional circuitry and modules can be incorporated to make the system 100 more complete. For example, the system 100 may further include power conditioning electronics to regulate the voltage and current from the solar panels to the actuator and other components. This can ensure that the cleaner receives a consistent power supply and operates efficiently. Other modules such as a wireless communication module or self-diagnostic circuitry can also be added, depending on the specific needs of the operation.

Many of the calculations and controls of the system may be performed by an on-board processor of the cleaner 200. However, one or more of these calculations and controls may also be performed by a computer configured to be independent from the cleaner. For example, the controller may be configured to output data to a computer which may perform further calculations as necessary for controlling the cleaner. The computer may be any computing system capable of performing computational functionalities. An example of the computer is illustrated in FIG. 6, which will be discussed in detail below.

FIGS. 2A to 2C show a schematic diagram of a cleaner 200 in one or more embodiments. In particular, FIG. 2A, FIG. 2B and FIG. 2C show different states of the cleaner 200 at various stages of a cleaning cycle.

The cleaner 200 may include a fixed arm 230 configured to be fixed relative to the solar panel to be cleaned. For example, the fixed arm 230 may be supported on a weight which is disposed near a solar panel. As another example, the fixed arm 230 may be fixed on a frame of the solar panel to be cleaned. The fixed arm 230 includes two fixed bars which are connected to each other at a connecting end and extend at an angle from each other. In particular, the fixed arm 230 may be configured to be L-shaped, with a first bar and a second bar extending to be perpendicular to each other.

The cleaner 200 may further include a moving arm 250 configured to move under the guidance of the fixed arm 230 on the surface of the solar panel to be cleaned. That is, the moving range of the moving arm 250 will be limited by the fixed bars of the fixed arm 230. The moving arm 250 may include two moving bars which are connected to each other at a connecting end and extend at an angle from each other. In particular, the moving arm 250 may be configured to be in the shape of L, with a first bar and a second bar extending to be perpendicular to each other. A cleaning brush may be disposed along each of the first moving bar and the second moving bar. While the moving arm 250 is moved on the surface of the solar panel to be cleaned, dust or dirt will be removed and collected by the cleaning brush from the surface of the solar panel.

The cleaner 200 may further include an actuator 290 configured to drive the moving arm 250 to move on the surface of the solar panel toward the connecting end of the first fixed bar and the second fixed bar of the fixed arm 230. The actuator 290 may include a motor (not shown in the figures) which may be powered by a battery or configured to receive power supply from the solar panel to be cleaned. The actuator 290 may be coupled to the moving arm 250 by means of a connector 240 which may transfer the rotation of the motor to a linear movement of the moving arm 250.

To start a cleaning cycle, the connected end of the moving arm 250 is positioned most far away from the connected end of the fixed arm 230 on a surface of the solar panel to be cleaned, as shown in FIG. 2A. While the moving arm 250 is driven by means of the connector 240 to move on the surface of the solar panel toward the connected end of the fixed arm 230, as shown in FIG. 2B, dust or dirt will be removed by the cleaning brush of the moving arm 250 from the surface of the solar panel. When the moving arm 250 finishes the cleaning cycle, the connected end of the moving arm 250 comes to be near the connected end of the fixed arm 230, and the dust or dirt is collected in one point surrounded by the moving arm 250 and the fixed arm 230, as shown in FIG. 2C. Then, the moving arm 250 may be driven by means of the connector 240 to move back to its starting position as shown in FIG. 2A for another cleaning cycle.

FIG. 3 is a perspective view of a cleaner 200 in one or more embodiments. FIG. 4 is a top view of the cleaner 200 of FIG. 3. As shown, the solar panel 210 to be cleaned includes a frame 211, and the cleaner 200 is positioned above the solar panel 210.

In general, the cleaner 200 includes a fixed arm 230 which is configured to be supported by a support 220, an actuator 290 which may be positioned within the support 220, and a moving arm 250 configured to be driven by the actuator 290 and guided by the fixed arm 230 to move on the surface of the solar panel 210. The support 220 is fixed on the frame 211 of the solar panel 210 to be cleaned. As another example, the support 220 may be fixed on a base near the solar panel 210.

The fixed arm 230 serves both as a support for a transmission mechanism from the actuator 220 to the moving arm 250 and a guide for the movement of the moving arm 250. As shown, the fixed arm 230 includes a first fixed bar 231 and a second fixed bar 232, the two being connected to each other at a connecting end 233 and extending at an angle from each other. For example, the fixed arm 230 may be formed to be in a shape of L, with the first fixed bar 231 and the second fixed bar 232 extending to be perpendicular to each other.

In particular, the support 220 extends vertically from the frame 211 of the solar panel 210 to be cleaned, and both the first fixed bar 231 and the second fixed bar 232 extend horizontally from an upper end of the support 220. Typically, the extensions of the first fixed bar 231 and the second fixed bar 232 need to cover or extend beyond the frame 211 of a solar panel 210 so as to guide the moving arm 250 to clean the entire surface of the solar panel 210.

A driving pulley 234 is disposed on the upper end of the support 220 near the connecting end 233 of the fixed arm 230. The driving pulley 234 is coupled to the actuator 290 which will provide rotation movement to the driving pulley 234. A first idle pulley 235 is disposed at a free end of the first fixed bar 231, and a second idle pulley 236 is disposed at a free end of the second fixed bar 232. Further, a first belt 241 extends between the driving pulley 234 and the first idle pulley 235, and a second belt 242 extends between the driving pulley 234 and the second idle pulley 236. In particular, both the first belt 241 and the second belt 242 are in the form of a loop such that the first belt 241 and the second belt 242 can be spontaneously driven to move linearly when the driving pulley 234 is actuated to rotate by the actuator 290.

The moving arm 250 includes a first moving bar 251 and a second moving bar 252 which are connected to each other at a connecting end and extend at an angle from each other. For example, the moving arm 250 may be formed in a shape of L, with the first moving bar 251 and the second moving bar 252 extending to be perpendicular to each other. Further, a cleaning brush 259 may be disposed along the first moving bar 251 and the second moving bar 252 such that, while the moving arm 250 is moved on the surface of the solar panel to be cleaned, dust or dirt will be removed and collected by the cleaning brush 259 from the surface of the solar panel.

Further, the first moving bar 251 of the moving arm 250 is provided with a first guiding slot 253 extending along most of the length of the first moving bar 251, and the second moving bar 252 is provided with a second guiding slot 254 extending along most of the length of the second moving bar 252.

Meanwhile, the first belt 241 is provided with a first pin 243 which is inserted into and sliding along the first guiding slot 253 of the first moving bar 251, and the second belt 241 is provided with a second pin 244 which is inserted into and sliding along the second guiding slot 254 of the second moving bar 252. In a cleaning cycle, the driving pulley 234 is driven by the actuator 290 to rotate, and further, the rotation of the driving pulley 234 is transmitted to the linear movements of the first belt 241 and the second belt 242. In particular, because the belts are coupled to the moving arm with the pins, the pins will move with the belts along the first fixed bar or the second fixed bar and slide along the first guiding slot or the second guiding slot, thereby the linear movements of the belts will be transmitted to the movement of the moving arm 250 toward the connecting end 233 of the fixed arm 230.

In FIG. 4, the first pin 243 is provided on the upper section of the first belt 241 and the second pin 244 is provided on the right section of the second belt 242. When the driving pulley 234 rotates counterclockwise as annotated in the figure, the first pin 243 moves along with the upper section of the first belt 241 from left to right, and the second pin 244 moves along with the right section of the second belt 242 from lower to upper, thereby the moving arm 250 is driven by both the first pin 243 and the second pin 244 toward the connecting end 233 of the fixed arm 230. A different configuration may be made, that is, the first pin 243 is provided on the lower section of the first belt 241 and the second pin 244 is provided on the left section of the second belt 242. Both of these configurations of pins on the belts may be feasible to transmit the linear movements of the belts to the movement of the moving arm 250 to and from the connecting end 233 of the fixed arm 230.

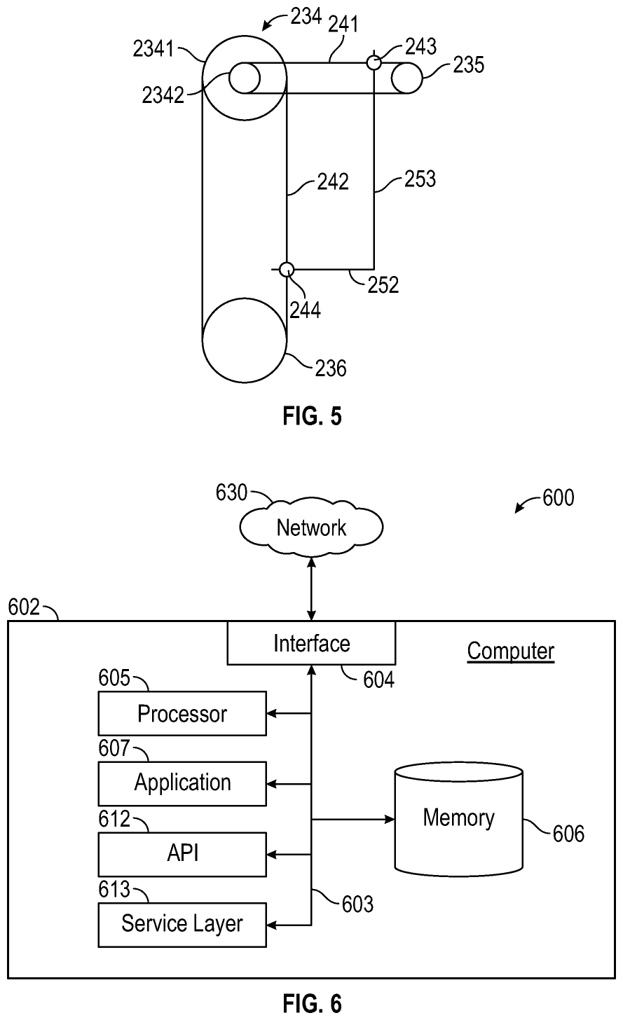

The speed of the belts and the pins may be varied by changing the diameter of the driving pulley 234. In one or more embodiments, the driving pulley 234 is provided with a plurality of longitudinal portions of different diameters. As illustrated in FIG. 5, the driving pulley 234 is formed with a first portion 2341 of the larger diameter and a second portion 2342 of the smaller diameter. When the first belt 241 and the second belt 242 are arranged around the same portion of the driving pulley 234, the first moving bar 251 and the second moving bar 252 are driven by the first belt 241 and the second belt 242 to move at the same speed, and thus this configuration is advantageous for cleaning a square solar panel. On the other hand, when the solar panel to be cleaned is rectangular with different dimensions of width and length, the first belt 241 and the second belt 242 can be arranged around the different portions of the driving pulley 234 with diameters corresponding to the different dimensions of width and length of the solar panel to be cleaned. In one or more embodiments, as shown in FIG. 5, the first portion 2341 and the idle second pulley 236 have the same dimeter, and the second portion 2342 and the first idle pulley 235 have the same dimeter. This configuration is advantageous for an L-shaped moving arm 250.

Though the driving pulley 234 is shown to include two longitudinal portions, other numbers of longitudinal portions of the driving pulley may be configured when appropriate or necessary, and the diameters of the portions may be chosen, for example, with regard to the dimensions of width and length of the solar panel to be cleaned.

FIG. 6 is a block diagram of a computer system 600 used to provide computational functionalities associated with described algorithms, methods, functions, processes, flows, and procedures as described in the instant disclosure, according to an implementation. The computer system 600 includes a computer 602 which is communicably coupled with a network 630. The illustrated computer 602 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 602 may include a computer that includes an input device, such as a keypad, keyboard, touch screen, or other device that can accept user information, and an output device that conveys information associated with the operation of the computer 602, including digital data, visual, or audio information (or a combination of information), or a GUI.

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 630 from a client application (for example, executing on another computer 602) and responding to the received requests by processing the said requests in an appropriate software application. In addition, requests may also be sent to the computer 602 from internal users (for example, from a command console or by other appropriate access method), external or third-parties, other automated applications, as well as any other appropriate entities, individuals, systems, or computers.

Each of the components of the computer 602 can communicate using a system bus 603. In some implementations, any or all of the components of the computer 602, both hardware or software (or a combination of hardware and software), may interface with each other or the interface 604 (or a combination of both) over the system bus 603 using an application programming interface (API) 612 or a service layer 613 (or a combination of the API 612) and service layer 613. The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems in a distributed environment that are connected to the network 630. Generally, the interface 604 includes logic encoded in software or hardware (or a combination of software and hardware) and operable to communicate with the network 630. More specifically, the interface 604 may include software supporting one or more communication protocols associated with communications such that the network 630 or interface's hardware is operable to communicate physical signals within and outside of the illustrated computer 602.

The computer 602 includes at least one computer processor 605. Although illustrated as a single computer processor 605 in FIG. 6, two or more processors may be used according to particular needs, desires, or particular implementations of the computer 602. Generally, the computer processor 605 executes instructions and manipulates data to perform the operations of the computer 602 and any algorithms, methods, functions, processes, flows, and procedures as described in the instant disclosure.

The computer 602 also includes a memory 606 that holds data for the computer 602 or other components (or a combination of both) that can be connected to the network 630. For example, memory 606 can be a database storing data consistent with this disclosure. Although illustrated as a single memory 606 in FIG. 6, two or more memories may be used according to particular needs, desires, or particular implementations of the computer 602 and the described functionality. While memory 606 is illustrated as an integral component of the computer 602, in alternative implementations, memory 606 can be external to the computer 602.

The application 607 is an algorithmic software engine providing functionality according to particular needs, desires, or particular implementations of the computer 602, particularly with respect to functionality described in this disclosure. For example, application 607 can serve as one or more components, modules, applications, etc. Further, although illustrated as a single application 607, the application 607 may be implemented as multiple applications 607 on the computer 602. In addition, although illustrated as integral to the computer 602, in alternative implementations, the application 607 can be external to the computer 602.

There may be any number of computers 602 associated with, or external to, a computer system containing computer 602, each computer 602 communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

In some embodiments, the computer 602 is implemented as part of a cloud computing system. For example, a cloud computing system may include one or more remote servers along with various other cloud components, such as cloud memory units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for cleaning a solar panel, the system comprising a cleaner, wherein the cleaner comprises:
a fixed arm configured to be fixed relative to the solar panel to be cleaned, wherein the fixed arm comprises a first fixed bar and a second fixed bar, which are connected with each other at a connecting end and form an angle to each other,
a moving arm configured to move under guidance of the fixed arm on the surface of the solar panel to be cleaned, wherein the moving arm comprises a first moving bar and a second moving bar, which are connected to each other at a connecting end and form an angle to each other, and
an actuator configured to drive the moving arm to move on the surface of the solar panel along both the first fixed bar and the second fixed bar toward the connecting end of the first fixed bar and the second fixed bar.

2. The system of claim 1, wherein
the fixed arm comprises a connector connected between the actuator and the moving arm for driving the moving arm by means of the actuator.

3. The system of claim 2, wherein
the connector is a belt or a chain.

4. The system of claim 1, wherein
the first moving bar is provided with a first guiding slot extending longitudinally, and
the second moving bar is provided with a second guiding slot extending longitudinally.

5. The system of claim 4, wherein the fixed arm comprises
a driving pulley disposed at the connecting end of the fixed arm and configured to be powered by the actuator,
a first idle pulley disposed at a free end of the first fixed bar,
a second idle pulley disposed at a free end of the second fixed bar,
a first belt or chain extending between the driving pulley and the first idle pulley, the first belt having a first pin inserted into and sliding along the first guiding slot, and
a second belt or chain extending between the driving pulley and the second idle pulley, the second chain having a second pin inserted into and sliding along the second guiding slot.

6. The system of claim 5, wherein
the driving pulley is provided with a plurality of longitudinal portions of different diameters.

7. The system of claim 1, wherein
the actuator is configured to receive power supply from the solar panel to be cleaned.

8. The system of claim 1, wherein the cleaner further comprises:
a controller for controlling the cleaner's motion and orientation.

9. The system of claim 1, wherein the cleaner further comprises:
a sensor for detecting changes of environment and status of the cleaner.

10. The system of claim 1, wherein the cleaner further comprises:
a user interface for setting, adjusting, and monitoring cleaning cycle of the cleaner.

11. A cleaner for cleaning a solar panel, the cleaner comprising:
a fixed arm configured to be fixed relative to the solar panel, wherein the fixed arm comprises a first fixed bar and a second fixed bar, which are connected to each other at a connecting end and are perpendicular to each other,
a moving arm configured to move under guidance of the fixed arm on the surface of the solar panel to be cleaned, wherein the moving arm comprises
a first moving bar and a second moving bar, which are connected to each other at a connecting end and are perpendicular to each other,
a cleaning brush disposed along each of the first moving bar and the second moving bar, and
an actuator configured to drive the moving arm to move on the surface of the solar panel along both the first fixed bar and the second fixed bar toward the connecting end of the first fixed bar and the second fixed bar.

12. The cleaner of claim 11, wherein
the fixed arm comprises a connector connected between the actuator and the moving arm for driving the moving arm.

13. The cleaner of claim 12, wherein
the connector is a belt or a chain.

14. The cleaner of claim 11, wherein
the first moving bar is provided with a first guiding slot extending longitudinally; and
the second moving bar is provided with a second guiding slot extending longitudinally.

15. The cleaner of claim 14, wherein the fixed arm comprises:
a driving pulley disposed at the connecting end of the fixed arm and configured to be powered by the actuator,
a first idle pulley disposed at a free end of the first fixed bar,
a second idle pulley disposed at a free end of the second fixed bar,
a first belt or chain extending between the driving pulley and the first idle pulley, the first belt having a first pin inserted into and sliding along the first guiding slot, and
a second belt or chain extending between the driving pulley and the second idle pulley, the second chain having a second pin inserted into and sliding along the second guiding slot.

16. The cleaner of claim 15, wherein
the driving pulley is provided with a plurality of longitudinal portions of different diameters.

17. The cleaner of claim 11, wherein
the actuator is configured to receive power supply from the solar panel to be cleaned.

18. A cleaner for cleaning a solar panel, the cleaner comprising
a moving arm configured to move along a surface of the solar panel, wherein the moving arm comprises:
a first moving bar and a second moving bar, which are connected to each other at a connecting end and are oriented to be perpendicular to each other, each of the first moving bar and the second moving bar having a guiding slot extending longitudinally, and
a cleaning brush disposed along the first moving bar and the second moving bar, a fixed arm configured to be fixed relative to the solar panel, wherein the fixed arm comprises:
a first fixed bar and a second fixed bar, which are connected to each other at a connecting end,
a driving pulley disposed at the connecting end of the fixed arm,
a first idle pulley disposed at a free end of the first fixed bar,
a second idle pulley disposed at a free end of the second fixed bar,
a first belt or chain extending between the driving pulley and the first idle pulley, the first belt or chain having a first pin inserted into and sliding along the guiding slot of the first moving bar,
a second belt or chain extending between the driving pulley and the second idle pulley, the second belt or chain having a second pin inserted into and sliding along the guiding slot of the second moving bar, and
an actuator configured to rotate the driving pulley.

19. The cleaner of claim 18, wherein
the actuator is configured to receive power supply from the solar panel to be cleaned.

20. The cleaner of claim 18, wherein
the driving pulley is provided with a plurality of longitudinal portions of different diameters.
